(19) United States
(12) Patent Application Publication
(10) Pub. No.: US 2002/0160327 A1
(43) Pub. Date: Oct. 31, 2002

(54) Colored flame candles and manufacturing method thereof

(76) Inventors: Jinman Lim, Seoul (KR); Younggu Kim, Dongduchon-city (KR)

Correspondence Address: MORRISON & FOERSTER LLP, 2000 PENNSYLVANIA AVE, NW, SUITE 5500, WASHINGTON, DC, 20006-1888, US

(21) Appl. No.: 09/793,104

(22) Filed: Feb. 27, 2001

(51) Int. Cl. F23D 3/16; C11C 5/00

(52) U.S. Cl. 431/126; 431/275

(57) ABSTRACT

The present invention relates to colored flame candles for decoration or lighting, and provides the manufacturing method for the colored flame candles containing fatty acid alcohols, aliphatic organic compounds, aliphatic surfactants unlike the conventional paraffin candles; coloring agents such as lithium stearate, boric acid, and copper (II) chloride; supporters; heat-resistant agents; and surfactants.

### BACKGROUND OF THE INVENTION

1. Field of the Invention

The present invention relates to colored flame candles for decoration or lighting, including such color as red, green, or blue, and relates to manufacturing method thereof.

2. Description of the Prior Art

The conventional candles for decoration or lighting have been paraffin candles, and coloring the surface of paraffin candles has been attempted in order to catch people's eyes. These candles for festival or decorative lighting could not however satisfy modern people's expectation.

Colored flame candles comprising coloring agents such as various metal oxides or their salts, solvents, adhesives, and heat-resistant agent have been reported in U.S. Pat. No. 5,127,922(1992), but these could not be adapted to candles with combustion wicks. In another case, the colored flame candles described in U.S. Pat. No. 4,386,904(1983) had weak points of inconvenient use and complicated manufacturing processes, wherein these candles included combustion materials such as ethyl carbamate, dimethyl oxalate, and/or trioxane instead of paraffin and stearic acid; their cotton combustion wick absorbing an oxidation accelerating catalyst; and an additional coloring wick adjacent the said cotton wick.

Considering such defects of the conventional prior art, the present invention is intended to provide colored flame candles including a single wick and simple manufacturing processes Further the present invention provides a manufacturing method for red, green or blue colored flame.

### SUMMARY OF THE INVENTION

The purpose of this invention is achieved by presenting manufacturing method for colored flame candles and then evaluating the method, which includes processes such as combining, heating, melting, injecting, and congelation,

wherein the combining process is to combine fatty acids such as stearic acid, lauric acid, myristic acid, palmitic acid, or adipic acid; or aliphatic organic compounds such as penta erysthritol or 1,5-pentane-diol with coloring agents such as lithium stearate, lithium compounds or

strontium compounds for red colored flames; boric acid for green colored flames; or copper (II) chloride or copper compounds for blue colored flames.

### BRIEF DESCRIPTION OF THE DRAWINGS

FIG. 1 is a longitudinal sectional view of colored flame candles of this invention.

FIG. 2 is a cross sectional view of colored flame candles of this invention.

FIG. 3 is a longitudinal sectional view of blue colored flame candles as an example of this invention.

FIG. 4 is a cross sectional view of blue colored flame candles as another example of this invention.

Description of main symbols in the Figures.

10: the colored flame candle

11: the copper wire producing blue colored flames

12: the wick of colored flame candle

14: the surface material

### DETAILED DESCRIPTION OF THE PREFERRED EMBODIMENTS

This invention presents manufacturing methods for producing colored flame candles, respectively for the different colors, comprising;

the step of heating and melting of combustion materials consisting of fatty acids or aliphatic organic compounds, followed by adding the coloring agent corresponding to each color; and

the step of inserting wicks into center of candles in extruding process.

The above-mentioned features and objects of the present invention will become more apparent with reference to the following description taken in conjunction with the accompanying drawings.

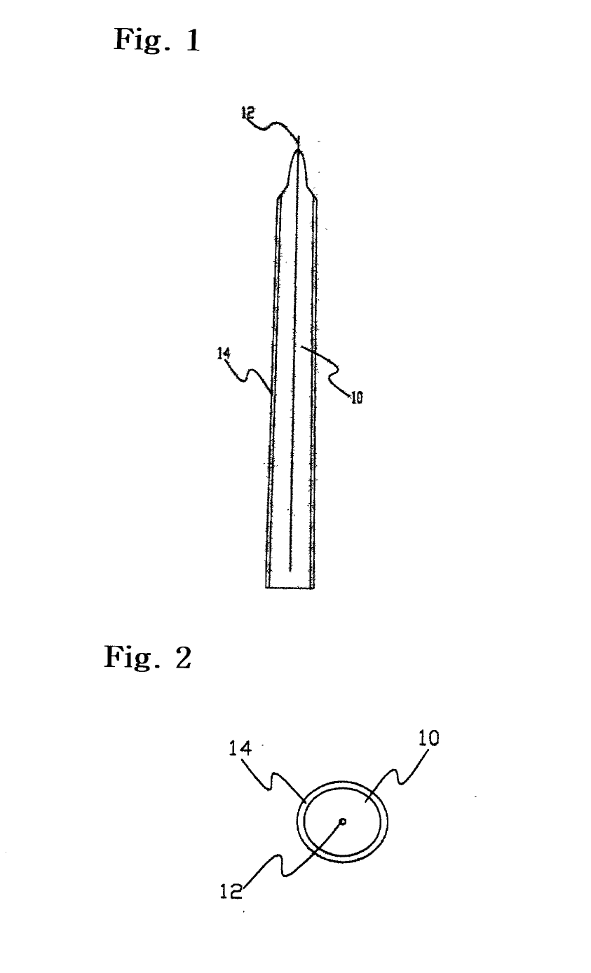

FIG. 1 and FIG. 2 show the colored flame candles(10), consisting of the part of central wick and the surface material surrounding the said wick.

In accordance with this invention, the colored flame candles(10) are composed of materials which can produce a luminous decoration-lighting of red, green, or blue color; the wick(12), which is weaved wholly with cotton, is located inside the candle; and the surface materials(14) are coated by penta erysthritol, which is characterized by high melting point enough to prevent candles guttering down.

In combustion of the candles(10), the surface materials(14) support to absorb and consume the candle materials(10) which melt down faster than the surface materials(14), and simultaneously play a role in sustaining at high temperature. In other words, the surface materials(14) prevent candles guttering down.

The colored flame candles(10) are composed of composition for colored flames exposing red or green color.

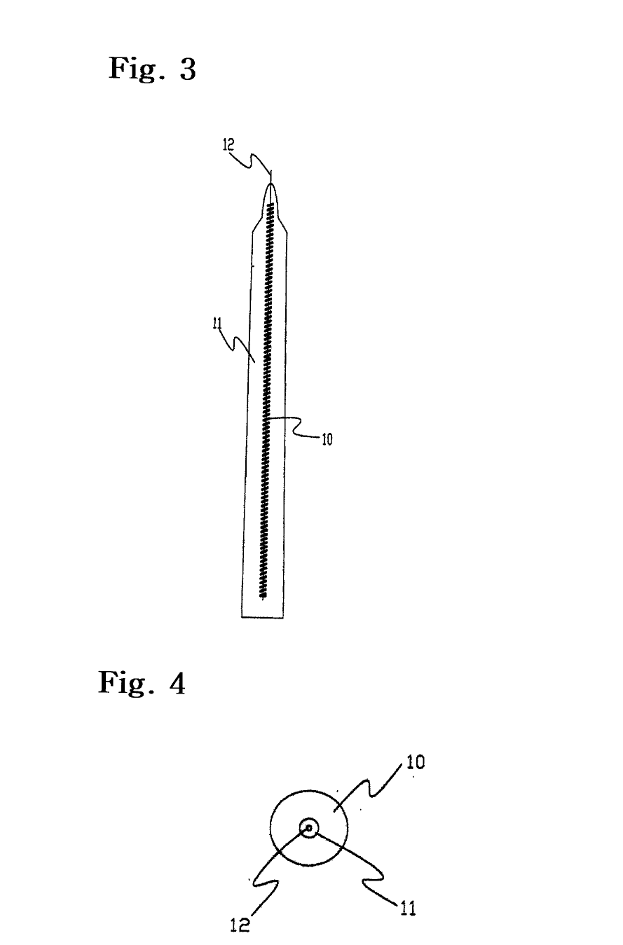

FIG. 3 and FIG. 4 show blue colored flame candles(10) as other examples based on this invention, wherein the candles(10) consist of the part of central wick(12) and the copper wire(11) spirally surrounding the wick.

In accordance with this invention, the blue colored flame candles(10) are composed of materials which can produce a luminous decoration-lighting of blue color; like the above example, the wick(12), which is weaved wholly with cotton, is located inside the candle; and the copper wire(11) spirally surrounding the wick is inserted in order to enhance exposing a blue flame unique to copper.

The composition of red colored flame candles is a solution of 0.5˜2.0% (w/w) of lithium stearate or lithium compounds in 4.0˜6.0%(w/w) of ethyl alcohol. Strontium compounds can be substituted with lithium compounds.

The composition of green colored flame candles is a solution of salts of boric acid comprising 5.0˜7.0%(w/w) of boric acid in 8.0˜10%(w/w) of ethyl alcohol.

The composition of blue colored flame candles is a composition of fatty acids or aliphatic organic compounds, that is, a solution of 4.0˜5.0%(w/w) of copper (II) chloride in 5.0˜8.0%(w/w) of ethyl alcohol.

Actual specific examples of candles constructed according with the teachings of the present invention will now be discussed in the following paragraphs, but they are not intended to limit the scope of the invention.

### EXAMPLE 1

Composition of red colored flame candles

| Ingredients | Ratio, % (w/w) |
|---|---|
| Stearic Acid | 20˜25 |
| Myristic Acid | 20˜25 |
| Adipic Acid | 20 |
| Penta erysthritol | 18 |
| 1,6-Hexane-diol | 7 |
| Lithium stearate | 3.5 |
| Strontium chloride | 1.5 |
| Polyoxyethylene Sorbitan mono Stearate | 6 |
| Total | 100 |

The above fatty acids of stearic acid, myristic acid, and adipic acid were melted in a stainless-steel container at 80° C., and pentaerysthritol together with 1,6-hexane-diol was added and heated to be uniformly mixed with the mixture of the fatty acids, and subsequently the resulting mixture was completely blended with a solution comprising lithium stearate and strontium chloride as red coloring agents dissolved in polyoxyethylene sobitan mono stearate as a surfactant, and the final mixture was poured into molding frames and cooled to yield the above red colored flame candles.

### EXAMPLE 2

Composition of green colored flame candles

| Ingredients | Ratio, % (w/w) |
|---|---|
| Stearic Acid | 20˜25 |
| Lauryl Acid | 20˜25 |
| Adipic Acid | 20 |
| Penta erysthritol | 18 |
| 1,6-Hexane-diol | 7 |
| Boric Acid | 7 |
| Dodecylbenzene Sodium Sulfonate | 6 |
| Total | 100 |

The above fatty acids of stearic acid, lauryl acid, and adipic acid were melted in a stainless-steel container at 80° C., and pentaerysthritol together with 1,6-hexane-diol was added and heated to be uniformly mixed with the mixture of the fatty acids, and subsequently the resulting mixture was completely blended with a solution comprising boric acid as a green coloring agent dissolved in dodecyl-benzene sodium sulfonate as a surfactant, and the final mixture was poured into molding frames and cooled to yield the above green colored flame candles.

### EXAMPLE 3

Composition of blue colored flame candles

| Ingredients | Ratio, % (w/w) |
|---|---|
| Stearic Acid | 22 |
| Palmitic Acid | 18 |
| Adipic Acid | 20 |
| Penta erysthritol | 19 |
| 1,6-Hexane-diol | 6 |
| Copper (II) chloride | 6.5 |
| Dodecylbenzene Sulfonic Acid | 8.5 |
| Total | 100 |

The above fatty acids of stearic acid, palmitic acid, and adipic acid were melted in a stainless-steel container at 80° C., and pentaerysthritol together with 1,6-hexane-diol was added and heated to be uniformly mixed with the mixture of the fatty acids, and subsequently the resulting mixture was completely blended with a solution comprising copper (II) chloride as a blue coloring agent dissolved in dodecyl-benzene sulfonic acid as a surfactant, and the final mixture was poured into molding frames, at the same time inserting the copper-wire wick, wherein the copper-wire wick was prepared by spirally winding round the wick with the spiral copper wire in 4Φ diameter, into which a copper wire in 0.2Φ diameter was transformed. And then more cooling step yielded the above blue colored flame candles. The reason that the copper wire was inserted into the candle is (1) that when used in large amount, copper (II) chloride is harmful to human body and wick hardening caused by large amount of copper (II) chloride becomes an obstacle against continuous combustion; and (2) insufficient blue colored flames produced by burning of small amount of copper (II) chloride can be supplemented with the red-heat flame of the copper wire producing blue colored flames. In this manner, minimum amount of toxic metals makes maximum desirable effect.

As the above mentioned embodiments, the present invention provide the candles which can produce luminous lightings of red, green, or blue color; emit no smell or no smoke; and make charming mood in celebration or banquet parties. Moreover, this invention is a significant progress in the candle industry or the manufacturing industry of decorations, in the view that candles of this invention can maintain for long time not guttering down because of higher melting point than paraffin candles; and the candles of this invention are excellent in production of a subtle perfume or a charming mood.

What is claimed is:

1. A manufacturing method for producing colored flame candles, comprising;
the step of providing combustion materials consisting of fatty acids and aliphatic organic compounds;
the step of providing the candle composition for green flame containing boric acid, the candle composition for red flame containing lithium compounds and/or strontium compounds, and the candle composition for blue flame containing copper (II) chloride and the corresponding compounds; and
the step of melting selected one from the said candle compositions with heat, and subsequently pouring the melted composition into molding frames with wicks, followed by cooling and solidifying.

2. A manufacturing method according to claim 1, wherein the combustion materials consist of (1) two or more fatty acids selected from the group comprising stearic acid, myristic acid, lauryl acid, or adipic acid; as aliphatic organic compounds, (2) pentaerysthritol and (3) 1,6-hexane-diol.

3. A manufacturing method for producing red colored flame candles according to claim 1, wherein the said candles consist of lithium compounds and/or strontium compounds as coloring agents; pentaerysthritol and 1,6-hexane-diol as aliphatic organic compounds.

4. A manufacturing method for producing green colored flame candles according to claim 1, wherein the said candles consist of boric acids as a coloring agent and dodecyl-benzene sodium-sulfonate as a surfactant.

5. A manufacturing method for producing blue colored flame candles according to claim 1, wherein the said candles consist of copper (II) chloride as a coloring agent and dodecyl-benzene sulfonic acid as a surfactant, and further include winding of copper wire spirally around candle wick.
